(19) United States
(12) Patent Application Publication
(10) Pub. No.: US 2026/0195188 A1
(43) Pub. Date: Jul. 9, 2026

(54) SYSTEMS AND METHODS FOR RECOMMENDING ARTIFICIAL INTELLIGENCE MODELS

(71) Applicant: ThisWay Global, Inc., Austin, TX (US)

(72) Inventor: Angela Hood, Austin, TX (US)

(21) Appl. No.: 19/012,974

(22) Filed: Jan. 8, 2025

(51) Int. Cl. G06F 9/50

(52) U.S. Cl. CPC G06F 9/5055

(57) ABSTRACT

Disclosed is a system (100) for recommending Artificial Intelligence (AI) model, system comprising processing unit (102) that is being configured to: receive first input (FI) comprising application requirement of user; process FI and compare said FI to each AI model from amongst AI models, to determine AI model(s) that match FI; receive second input (SI) comprising data related to FI, from user device (104); process SI by each AI model(s) to generate response(s); evaluate each response to determine ranking of corresponding AI models based on relevance to SI; when ranking of corresponding AI models lies above predefined threshold, identify set of AI models from AI model(s); and generate first unique code (FUC) for each AI model of set, wherein FUC of corresponding AI model is sent to user device, as selected by user, to allow said user device to access any AI model of set.

### TECHNICAL FIELD

The present disclosure relates to systems for recommending artificial intelligence (AI) models. The present disclosure relates to methods for recommending artificial intelligence (AI) models.

### BACKGROUND

The rapid advancement of artificial intelligence (AI) technologies has led to expansion of various AI models (such as, language models) designed to perform a wide range of tasks, from natural language processing to specialized domain-specific applications. These AI models have demonstrated significant capabilities in understanding and meeting user requirements, making them invaluable tools in fields ranging from customer support to content creation and data analysis. The versatility and power of these AI models have created a demand for their integration into business processes to enhance efficiency, automate repetitive tasks, and provide advanced analytics. There already exists a multitude of AI models. Herein, AI engines comprise application programming interfaces (APIs), for which different AI models are required. However, each of the multitude of AI models caters to different user requirements. This makes it difficult for the user to choose a right AI model as per their requirement.

Conventionally, existing solutions to said problem primarily involve manual selection of the AI models by specialized professionals (such as an AI-trained professional). The specialized professionals are tasked with understanding the specific needs of the company, evaluating capabilities of numerous available models, and selecting the most appropriate one. However, there is a scarcity of such specialized professionals. Furthermore, even if the specialized professional is employed by the user, they may not immediately understand or be familiar with intricacies of the user requirement. Moreover, different AI models are tested and integrated separately. Thus, the process is time-consuming, resource-intensive, and often prone to errors due to subjective nature of model evaluation. Additionally, there is a lack of integration for common programming languages.

Therefore, in light of the foregoing discussion, there exists a need to overcome the aforementioned drawbacks.

### SUMMARY

The aim of the present disclosure is to provide a system and a method for recommending artificial intelligence (AI) models to provide at least one AI model that is best suited to meet application requirements of a user of a user device. The aim of the present disclosure is achieved by system and a method for recommending artificial intelligence (AI) models as defined in the appended independent claim to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of system for recommending an Artificial-Intelligence (AI) model, in accordance with an embodiment of the present disclosure;

FIG. 2 shows an exemplary process flow of recommending an Artificial-Intelligence (AI) model in an automatic manner, in accordance with an embodiment of the present disclosure;

FIG. 3 shows an exemplary process flow of recommending an Artificial-Intelligence (AI) model in semi-automatic manner, in accordance with an embodiment of the present disclosure; and

FIG. 4 shows a flowchart illustrating steps of a method of recommending an Artificial Intelligence (AI) model, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides system for recommending an Artificial Intelligence (AI) model, the system comprising a processing unit that is being configured to:
receive a first input, from a user device associated with a user, upon receiving a user prompt at a user interface of the user device, wherein the first input comprises an application requirement of the user;
process the first input and compare said first input to each AI model from amongst a plurality of AI models, to determine one or more AI models from amongst the plurality of AI models that match the first input;
receive a second input, from the user device, the second input comprising data related to the first input;
process the second input by each of the one or more AI models to generate at least one response;
evaluate each of the at least one response to determine a ranking of corresponding AI models based on their relevance to the second input;
when the ranking of corresponding AI models lies above a predefined threshold, identify a set of AI models from amongst the one or more AI models; and
generate a first unique code for each AI model of the set, wherein the first unique code of corresponding AI model of the set is sent to the user device, as selected by the user, to allow said user device to access any AI model of the set.
In a second aspect, the present disclosure provides method for recommending an Artificial Intelligence (AI) model, the method comprising:
receiving a first input, from a user device associated with a user, upon receiving a user prompt at a user interface of the user device, wherein the first input comprises an application requirement of the user;
processing the first input and compare said first input to each AI model from amongst a plurality of AI models, to determine one or more AI models from amongst the plurality of AI models that match the first input;
receiving a second input, from a user device associated with a user, the second input comprising data related to the first input;
processing the second input by each of the one or more AI models to generate at least one response;
evaluating each of the at least one response to determine a ranking of corresponding AI models based on their relevance to the second input;
when the ranking of corresponding AI models lies above a predefined threshold, identifying a set of AI models from amongst the one or more AI models; and
generating a first unique code for each AI model of the set, wherein the first unique code of corresponding AI model of the set is sent to the user device, as selected by the user, to allow said user device to access any AI model of the set.

The present disclosure provides the aforementioned system and the aforementioned method for recommending the AI model. The processing unit is configured in such a manner that the set of AI models from amongst the plurality of AI models is determined, to meet particular application requirements of the user of the user device. The set provides different responses when the second input is provided, based on which it can be determined which AI model(s) of the set suits the application requirement. Herein, the set of AI models are recommended at the user device, which can be further processed. Moreover, the set of AI models is only created and/or adjusted for the user using the system, and is not shared with general public, thus providing a sense of security. The aforementioned system is robust, uses less processing resources, and time-saving. Moreover, the aforementioned method is easy to implement.
The first input is provided by the user device associated with the user (namely, a client, a contractor), to browse through the plurality of AI models. Optionally, the AI model comprises a language model. In this regard, the first input comprises at least one of: a feature request, a configuration setting, a user-defined parameter. The first input is triggered by the user prompt, when the user is interacting with the user interface, likely via a graphical user interface (GUI). Herein, the user interface relates a structured set of user interface elements rendered on a display screen of the first user device. Optionally, the user interface rendered on the display screen is generated by any collection or set of instructions executable by an associated digital system. Additionally, the user interface is operable to interact with the user to convey graphical and/or textual information and receive input from the user; it will be appreciated that “A and/or B” means either A or B, or both A and B. Moreover, the user prompt is provided upon creation of a user account using the user interface. As a first example, the user interface may provide a search box, wherein the user prompt may be, “Tool objective”. The first input that may be provided at the search box may be, “I want a legal research tool”.

Throughout the present disclosure, the term “user device” refers to an electronic device associated with (or used by) a user that is capable of enabling the user to provide the first input upon receiving the user prompt. Furthermore, the user device is intended to be broadly interpreted to include any electronic device that may be used for voice and/or data communication over a communication network. Examples of the user device may include, but are not limited to, mobile phones, personal digital assistants (PDAs), laptop computers, and tablet computers. Additionally, the user device includes a memory, a processor, a display, a network interface card, a microphone, a speaker, a keypad, and an actuator (for example, such as a vibration motor).

It will be appreciated that the at least one processor is communicably coupled to the user device. The at least one processor could be implemented as any one of: a microprocessor, a microcontroller, or a controller. As an example, the at least one processor could be implemented as an application-specific integrated circuit (ASIC) chip or a reduced instruction set computer (RISC) chip.

The at least one processor is configured to process the first input in a secluded environment, in parallel computation threads. Herein, processing the first input could include at least one of: parsing the first input, analyzing content of the first input, converting the first input into a data format that can be used for further processing. The plurality of AI models are sorted based on matching the first input with the category of the plurality of AI models via an algorithmic pathway (for example, such as ranking each of the plurality of AI models). The one or more AI models are categorized based on the first input, wherein such categorization could be according to a field or a specialization.

The second input comprises at least one of: contextual information related to the first input, a sample dataset. The contextual information could comprise at least one of: a filter option, a capability, for/or the application. Moreover, the sample dataset is relevant to the user. Advantageously, the second input is utilised by the one or more AI models to provide at least one response that could be relevant to the application requirements of the user. Continuing in reference with the first example, the second input may comprise at least one of: a legal domain, a jurisdiction, a keyword, a statute, an example case law.

The second input is processed to leverage capabilities of the one or more AI models to address the application requirements of the user, as specified in the second input. Each of the one or more AI models work on the second input independently, or optionally, collaboratively. In this regard, an algorithm is employed to categorize the one or more AI models to match the second input, by a set of characteristics in the algorithm. Such algorithm could comprise a set of rules or procedures to classify the one or more AI models into different categories. Moreover, the set of characteristics could be one or more of specific attributes or features of the one or more AI models that are used for the categorization. Consequently, at least one response is generated by each of the one or more AI models, wherein the response could be at least one of: an answer, a recommendation, a prediction.

Continuing in reference with the first example, the second input may be processed to analyse and print a response (for example, such as an answer) from each of the one or more AI models, to a related question or a prompt. The responses can be compared if the application requirement may be to have more engineering aspect, than legal writing.

Subsequently, each response of corresponding one or more AI models can be compared based on the first input for evaluation. Herein, such evaluation comprises assessing the quality, accuracy, and appropriateness of the responses in relation to the second input. Based on this evaluation of the at least one response from the one or more AI models, the processing unit is configured to rank the one or more AI models. Such ranking indicates which of the one or more AI models provide responses that are relevant to the second input, wherein such AI models are ranked high. Herein, by ranking the one or more AI models, best performing AI models (i.e., the AI model that is most relevant to the second input) can be prioritized for further use or recommendation.

The processing unit is configured to rank the one or more AI models based on their relevance to the second input. Subsequently, it is determined whether the ranking of the one or more AI models is above the predefined threshold, to filter and select only relevant and high-performing AI models from the one or more AI models. Herein, the term “predefined threshold” refers to a minimum acceptable ranking for the one or more AI models to be considered to be sent to the user device. Optionally, the predefined threshold lies in a range of 4 to 7 on a scale of 1 to 10, 1 being highest rank and 10 being lowest rank. When the ranking of any of the one or more AI model is above the predefined threshold, the processing unit is configured to identify such one or more AI model as the set of AI models. Herein, this set comprises those AI models from amongst the one or more AI models whose responses are relevant to the second input, and have been ranked above the predefined threshold.

Throughout the present disclosure, the term “unique code” refers to a distinct identifier that is generated to represent or access the set of AI models. Herein, the unique code (namely, a security key, a unique key, a unique user identifier, a token) emulates an authorization token that permits the user device to connect to and use the set of AI models. In this regard, the unique code could be generated by using any one of: an algorithm, a randomization process, that ensures that the unique code is different for each AI model of the set. Once the first unique code is generated, the processing unit transmits said first unique code corresponding to each AI model of the set directly to the user device. Such transmission occurs over a secure communication channel to ensure confidentiality of the first unique code. In this regard, the user has an ability to select the AI model to be deployed at the user device. Hence, the first unique code that is sent to the user device enables said user device to access selected AI model of the set. Subsequently, there is automatic acquisition of the AI model of the set by initial logical test with the second input with the user device.

Optionally, the processing unit is further configured to:
receive a user request, from the user device, wherein the user request comprises the first unique code;
process the user request to identify the corresponding AI model of from the set, based on the first unique code; and
transmit the corresponding AI model to the user device,
   wherein the user device comprises a processor that is communicably coupled with the processing unit, the processor being configured to:
receive the corresponding AI model at the user device;
evaluate a performance of the corresponding AI model, based on an example dataset related to the first input; and
generate and send feedback report of the performance of the corresponding AI model, to the processing unit.

Herein, the processing unit is configured to receive the first unique code of the AI model of the set from the user device, that was previously generated and sent to the user device. The processing unit is configured to use the first unique code to identify which AI model from the set corresponds to that first unique code. Such identification can be performed by any one of: searching a database that comprises the set, a mapping table where each first unique code is linked to a particular AI model of the set. The processing unit is then configured to send the AI model to user device. Such transmission could involve transferring the AI model of the set itself, or providing data and instructions for the user device to access and utilise the AI model of the set.

Moreover, the user device comprises the processor, which is same as or different from the processing unit. The processor of the user device receives the AI model of the set, which is then used to evaluate the performance of the AI model. In this regard, an example dataset that is related to the first input provided by the user, is provided to the AI model of the set. Such evaluation can be performed for a predefined time duration, wherein the predefined time duration comprises a week, a month, 2 months, and so forth. Hence, the evaluation assess how well the AI model of the set performs tasks related to the first input, based on the example dataset. In this regard, a result of processing the example dataset is categorized through any one of: a quality criteria, a logical criteria. Such evaluation is then compiled into the feedback report (namely, a summary), wherein the feedback report provides detailed information regarding performance of the AI model of the set. This feedback report is then sent back to the processing unit, to provide insights into how effectively the AI model of the set is functioning.

A technical effect of the aforementioned feature is that, the evaluation and feedback report can improve the AI models of the set by providing feedback on their effectiveness in real-world scenarios. Beneficially, such feedback loop is essential for refining the AI models of the set.

Optionally, wherein the processing unit is further configured to:
receive the feedback report of the performance of the corresponding AI model;
employ an algorithm to determine whether the feedback report satisfies a given criteria;
when the feedback report satisfies the given criteria, generate an integration code to customize the corresponding AI model, based on at least one programming language selected from a plurality of programming languages, by the user of the user device; and
send the integration code to the user device,
wherein the processor is configured to:
receive the integration code; and
incorporate the integration code into a source code of the application.

Herein, the processing unit, upon receiving the feedback report, uses the algorithm to analyse the feedback report and check whether the feedback report meets the given criteria. Herein, the given criteria is at least one of: a performance threshold, an accuracy level, a quality metric. The given criteria ensures that the AI model of the set is functioning as expected before proceeding with further steps.

When the feedback report meets the given criteria, the processing unit generates an integration code, wherein the integration code is generated to customize the AI model of the set based on the first input. The integration code is generated using at least one programming language, which the user of the user device selects from the plurality of programming languages that are available to the user. Beneficially, selection of such programming language allows flexibility in how the integration code is generated. Upon generation of the integration code, said integration code is then transmitted to the user device. This integration code is then integrated with the AI model of the set into the application, by the processor of the user device. Optionally, the integration code is generated to integrate multiple AI models of the set. Optionally, the integration code is generated to integrate multiple AI models of the set to create a single AI model having functionality of the multiple AI models of the set.

When the feedback report does not meet the given criteria, integration code is not generated, and the AI model of the set that was accessed using the first unique code by the user device is deployed at the user device as is.

A technical benefit of the incorporation of the integration code with the source code of the application is that it facilitates customization of the application according to the application requirements and the programming language that was selected. A technical effect of selecting the programming language from amongst the plurality of programming languages is to facilitate integration of the AI models of the set using the programming language as required by the user.

Optionally, after determining one or more AI models from amongst the plurality of AI models that match the first input, the processing unit is configured to:
receive a third input, from the user device, specifying a foundation AI model from the one or more AI models;
provision the foundation AI model to a private model set;
receive input, from the user device, specifying a data format from a plurality of data format options, for a training data;
receive the training data from the user device, based on the data format;
process the training data to train the private model set, based on at least one training option selected by the user;
evaluate a performance of the private model set, using a test dataset; and
when the performance of the private model satisfies another given criteria, generate a second unique code for the private model set, wherein the second unique code is sent to the user device to allow said user device to access the private model set.

In this regard, the user of the user specifies the foundation AI model, the data format, and the training data, which is then used by the processing unit to train and evaluate the private model set. Herein, the term “foundation AI model” refers to a base model that serves as a starting point for further integration and training. This foundation model is selected from the one or more AI models that were already selected based on the first input. Notably, the foundation AI model that is selected by the user of the user device comprises a particular programming language that could be selected by the user. This foundation AI model can be made private by the user before evaluating the performance of the foundation AI model. Beneficially, this eradicates a security concern for security of any data that is to be provided to the foundation model.

Subsequently, the data format is selected from the plurality of data format options. Herein, the data format will be used to structure and interpret the training data that will be provided by the user later. It will be appreciated that different data formats may be required depending on a type of the training data and/or the first input.

Subsequently, the processing unit is configured to receive the training data from the user device. This training data is structured according to the data format that was selected by the user, from amongst the plurality of data format options. The processing unit is configured to use the training data to train the private model set. This training is guided by the at least one training option (for example, such as, a training algorithm, a learning rate, number of epochs, and so forth), as selected by the user. The at least one training option influences how the private model set learns from the data and adapts to the first input.

Subsequently, after training, the processing unit is configured to evaluate the performance of the private model set by testing said private model set against the test dataset. Herein, the test dataset is separate from the training dataset. The training data and the test dataset is sent from the user device to the system in a wireless manner (for example, such as via Internet).

This evaluation helps determine how well the private model set has learnt and whether it meets the desired performance levels. When it is determined that the private model set satisfies the another given criteria, the second unique code is generated, wherein the second unique code uniquely identifies the private model set. The processing unit is configured to send the second unique code to the user device, enabling the user device to access the private model set. The second unique code is different from the first unique code. When it is determined that the private model set does not satisfy the another given criteria, remaining of the plurality of AI models are browsed to determine the foundation model, based on the first input.

It will be appreciated, that the training data and/or the test data can be deleted by the user. The system does not store any copy of the training data and/or the test data. However, there is an option of keeping the training data and/or the test data within a memory of the system. Beneficially, this can be helpful in case the training data and/or the test data is to be provided to test different AI models from amongst the plurality of AI models.

A technical effect of configuring the private model set in such a manner is that the one or more AI models can be provided in a secluded mode, which prevents leakage of data outside the memory of the system. Another technical effect is that it allows the user to have control over training of the private model set, thus tailoring the foundation AI model according to the first input.

Optionally, the processing unit is further configured to:
determine whether an integration code for the private model set is required;
when it is determined that the integration code for the private model set is required, generate the integration code to customise the private model set, based on at least one programming language selected from a plurality of programming languages, by the user of the user device; and
send the integration code of the private model set to the user device,
   wherein the processor is further configured to:
receive the integration code of the private model set; and
incorporate said integration code into a source code of the application.

Herein, the requirement of the integration code is determined based on an evaluation of the performance of the private model set, based on the test data. When the response is relevant to the first input and satisfies the given criteria, the processing unit is configured to generate the integration code. The integration code is generated, transmitted, and incorporated in a similar manner as described above

A technical effect of configuring the processing unit and the processor in such a manner is that it enables further customization of the foundation AI model, to make it relevant to the first input.

Optionally, the processing unit is further configured to send the at least one of: the first unique code, the second unique code, to another user device associated with another user. Optionally, the processing unit is further configured to send the at least one of: the first unique code, the second unique code, to at least one other user device associated with other user of the system. Optionally, the processor of the user device is further configured to send the at least one of: the first unique code, the second unique code, to yet another user device associated with yet another user. Herein, the user device, the at least one other user device, the another user device, and the yet another user device are different from each other.

Optionally, the user device comprises a plurality of specialised AI models that can be provided at the yet another user device associated with yet another user. Herein, such specialised AI models could be a basic AI model, or an integrated AI model (i.e., the integration code being incorporated into the source code of the application). Subsequently, the processor of the user device is configured to generate a third unique code for each specialised AI model of the plurality of specialised AI models. The third unique code of the corresponding specialised AI model is sent to the another user device, as selected by the another user, to allow said another user to access any specialised AI model of the set.

Optionally, prior to generating the first unique code for each AI model of the set, the processing unit is further configured to:
collect user data that is related to the user of the user device;
perform data segmentation to identify user-specific data from the user data, that is relevant to train each AI model of the set;
train each AI model of the set, based on the user-specific data;
test each AI model of the set, based on a separate dataset of the user-specific data.

Herein, the user data comprises at least one of: a behavioural data, a contextual data, a demographic data. Additionally, the user data is indicative of business objectives of the user of the user device. The user data is collected from databases coupled with the processor of the user device. The processing unit is then further configured to process the user data to segment it into relevant categories. In this regard, such segmentation could involve feature selection, wherein the features relevant to behaviour and interactions of the user of the user device that directly contribute to improving each AI model of the set, are selected. In this regard, the data segmentation is performed to also identify sensitive information (for example, trade secrets, proprietary algorithms, and the like) from the user data, which is not used for training each AI model of the set. Thereafter, each AI model of the set are trained on the user data. Moreover, each AI model of the set of the are fine-tuned by fine-tuning hyperparameters and algorithms, based on each user's user data, rather than transferring parameters of the set of AI models from one user device to another user device. Subsequently, each AI model of the set are tested to evaluate how accurately their performance is, based on the separate dataset of the user data. A technical effect of the aforementioned feature is that each AI model of the set is not replicated from one user device to another user device, thus ensuring that the recommendations of each AI model of the set are uniquely tailored to each user's requirements.

Optionally, the processing unit is further configured to generate and assign a third unique code to the user device. Such generation of the third unique code is used to track interactions between the system and the user device over time, without relying on information that can personally identify the user. Such third unique codes can be stored in a secure and encrypted format to protect against unauthorized access.

The present disclosure also relates to the second aspect as described above. Various embodiments and variants disclosed above, with respect to the aforementioned first aspect, apply mutatis mutandis to the second aspect.

### DETAILED DESCRIPTION OF THE DRAWINGS

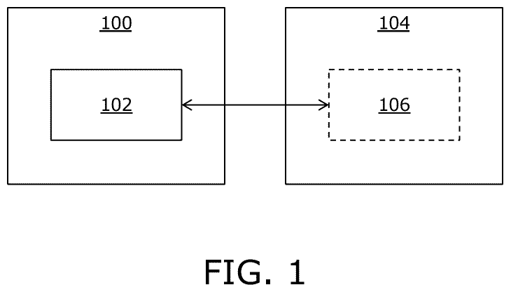

Referring to FIG. 1, illustrated is a block diagram of system 100 for recommending an Artificial-Intelligence (AI) model, in accordance with an embodiment of the present disclosure. The system 100 comprises a processing unit 102 and a user device 104. The processing unit 102 is optionally communicably coupled with a processor 106 of the user device 104.

FIG. 1 is merely an example, which should not unduly limit the scope of the claims herein. A person skilled in the art will recognize many variations, alternatives, and modifications of embodiments of the present disclosure.

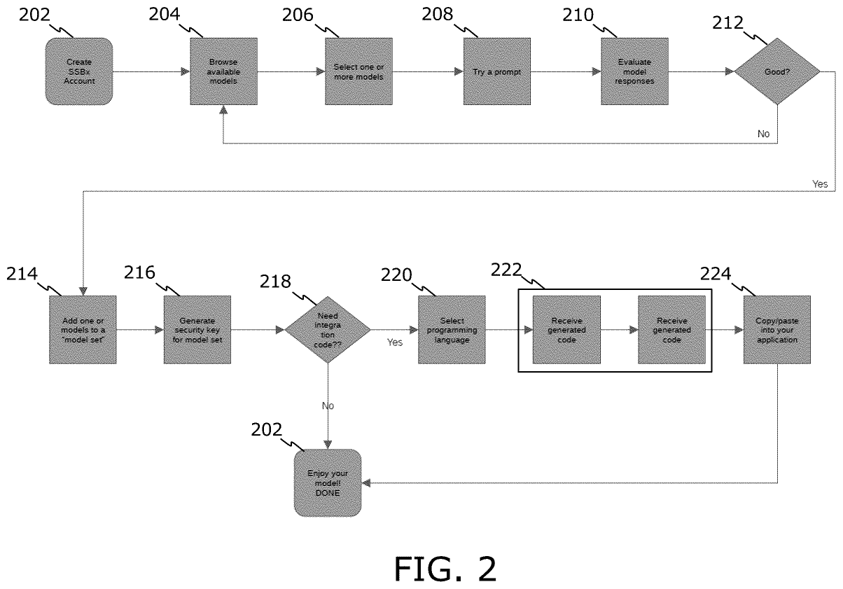

Referring to FIG. 2, there is shown an exemplary process flow of recommending an Artificial-Intelligence (AI) model in an automatic manner, in accordance with an embodiment of the present disclosure. At step 202, a user account (depicted as a Sully Sandbox (SSBx) account) for a user of a user device is created. At step 204, available AI models are browsed. At step 206, one or more AI models are selected. At step 208, a prompt is provided. At step 210, at least one response of the one or more AI models are evaluated, based on the prompt. At step 212, it is determined whether the at least one response of the one or more AI models is good. When it is determined that the at least one response of the one or more AI models is not good, return to step 204, to browse remaining AI models. When it is evaluated that the at least one response of the one or more AI models is good, at step 214, the one or more AI models are added to a model set. At step 216, a security key is generated for the model set. At step 218, it is determined whether there is a need for an integration code. When it is determined that there is a need for the integration code, at step 220, a programming language is selected. At step 222, the integration code that is generated using the programming language is received. At step 224, the integration code is incorporated (depicted as copy and paste) into a source code of the application. When it is determined that there is no need for the integration code, at step 226, the model set is provided at the user device without any modification.

FIG. 2 is merely an example, which should not unduly limit the scope of the claims herein. A person skilled in the art will recognize many variations, alternatives, and modifications of embodiments of the present disclosure.

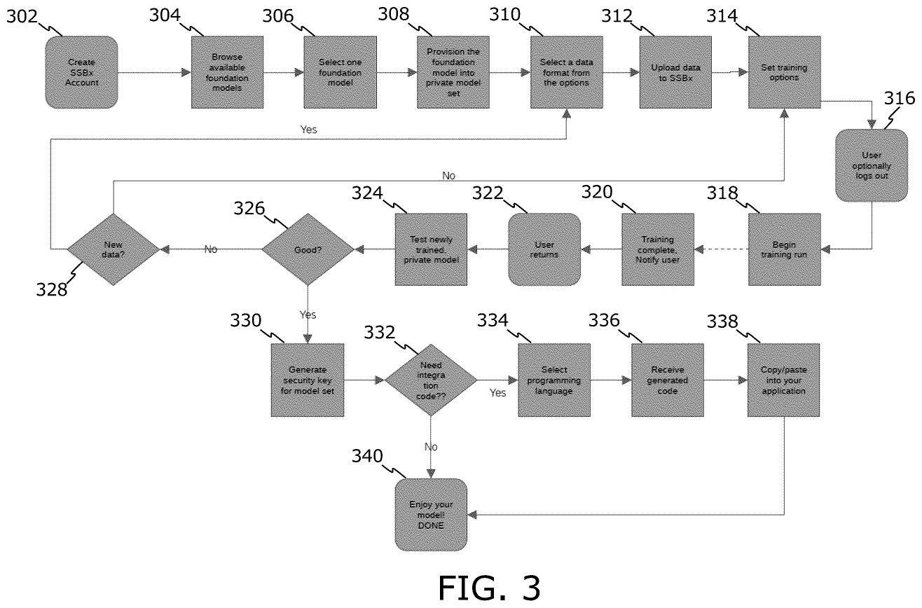

Referring to FIG. 3, there is shown an exemplary process flow of recommending an Artificial-Intelligence (AI) model in semi-automatic manner, in accordance with an embodiment of the present disclosure. At step 302, a user account (depicted as a Sully Sandbox (SSBx) account) for a user of a user device is created. At step 304, available AI models are browsed. At step 306, one foundation model is selected from the available AI models. At step 308, the foundation model is provisioned into a private model set. At step 310, a data format is selected from a plurality of options. At step 312, data is uploaded for the private model set. At step 314, training options are set for the private model set. At step 316, the user optionally logs out of the user account. At step 318, the private model set begins training on the data that was uploaded. At step 320, upon completion of the training of the private model set, the user is notified. At step 322, the user returns to their user account. At step 324, the private model set which is newly trained, is tested. At step 326, it is determined whether the training of the private model set is good. When it is determined that the training of the private model set is not good, at step 328, determine whether there is new data. When it is determined that there is new data, return to step 310, to select the data format from the plurality of options. When it is determined that there is no new data, return to step 314, to set other training options. When it is determined that that the training of the private model set is good, at step 330, generate a security key for the private model set. At step 332, it is determined whether there is a need for an integration code. When it is determined that there is a need for the integration code, at step 334, a programming language is selected. At step 336, the integration code that is generated using the programming language is received. At step 338, the integration code is incorporated (depicted as copy and paste) into a source code of the application. When it is determined that there is no need for the integration code, at step 340, the model set is provided at the user device without any modification.

FIG. 3 is merely an example, which should not unduly limit the scope of the claims herein. A person skilled in the art will recognize many variations, alternatives, and modifications of embodiments of the present disclosure.

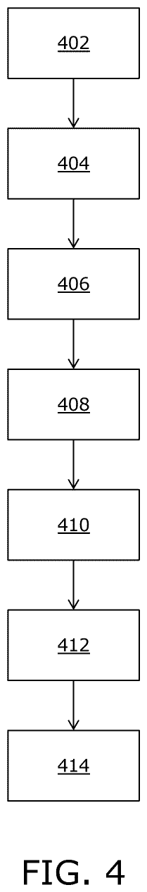

Referring to FIG. 4, there is shown a flowchart illustrating steps of a method of recommending an Artificial Intelligence (AI) model, in accordance with an embodiment of the present disclosure. At step 402, a first input is received, from a user device associated with a user, upon receiving a user prompt at a user interface of the user device, wherein the first input comprises an application requirement of the user. At step 404, the first input is processed and said first input is compared to each AI model from amongst a plurality of AI models, to determine one or more AI models from amongst the plurality of AI models that match the first input. At step 406, a second input is received, from the user device associated with a user, the second input comprising data related to the first input. At step 408, the second input is processed by each of the one or more AI models to generate at least one response. At step 410, each of the at least one response is evaluated to determine a ranking of corresponding AI models based on their relevance to the second input. At step 412, when the ranking of corresponding AI models lies above a predefined threshold, a set of AI models from amongst the one or more AI models is identified. At step 414, a first unique code is generated for each AI model of the set, wherein the first unique code of corresponding AI model of the set is sent to the user device, as selected by the user, to allow said user device to access any AI model of the set.

The aforementioned steps are only illustrative and other alternatives can also be provided where one or more steps are added, one or more steps are removed, or one or more steps are provided in a different sequence without departing from the scope of the claims herein.

What is claimed is:

1. A system (100) for recommending an Artificial Intelligence (AI) model, the system comprising a processing unit (102) configured to:
receive a first input, from a user device (104) associated with a user, upon receiving a user prompt at a user interface of the user device, wherein the first input comprises an application requirement of the user;
process the first input and compare said first input to each AI model from amongst a plurality of AI models, to determine one or more AI models from amongst the plurality of AI models that match the first input;
receive a second input, from the user device, the second input comprising data related to the first input;
process the second input by each of the one or more AI models to generate at least one response;
evaluate each of the at least one response to determine a ranking of corresponding AI models based on their relevance to the second input;
when the ranking of corresponding AI models lies above a predefined threshold, identify a set of AI models from amongst the one or more AI models; and
generate a first unique code for each AI model of the set, wherein the first unique code of corresponding AI model of the set is sent to the user device, as selected by the user, to allow said user device to access any AI model of the set.

2. The system (100) according to claim 1, wherein the processing unit (102) is further configured to:
receive a user request, from the user device (104), wherein the user request comprises the first unique code;
process the user request to identify the corresponding AI model of from the set, based on the first unique code; and
transmit the corresponding AI model to the user device, wherein the user device comprises a processor (106) that is communicably coupled with the processing unit, the processor being configured to:
receive the corresponding AI model at the user device;
evaluate a performance of the corresponding AI model, based on an example dataset related to the first input; and
generate and send feedback report of the performance of the corresponding AI model, to the processing unit.

3. The system (100) according to claim 2, wherein the processing unit (102) is further configured to:
receive the feedback report of the performance of the corresponding AI model;
employ an algorithm to determine whether the feedback report satisfies a given criteria;
when the feedback report satisfies the given criteria, generate an integration code to customize the corresponding AI model, based on at least one programming language selected from a plurality of programming languages, by the user of the user device (104); and
send the integration code to the user device, wherein the processor (106) is configured to:
receive the integration code; and
incorporate the integration code into a source code of the application.

4. The system (100) according to claim 1, prior to generating the first unique code for each AI model of the set, the processing unit is further configured to:
collect user data that is related to the user of the user device;
perform data segmentation to identify user-specific data from the user data, that is relevant to train each AI model of the set;
train each AI model of the set, based on the user-specific data; and
test each AI model of the set, based on a separate dataset of the user-specific data.

5. The system (100) according to claim 1, wherein after determining one or more AI models from amongst the plurality of AI models that match the first input, the processing unit (102) is configured to:
receive a third input, from the user device (104), specifying a foundation AI model from the one or more AI models;
provision the foundation AI model to a private model set;
receive input, from the user device, specifying a data format from a plurality of data format options, for a training data;
receive the training data from the user device, based on the data format;
process the training data to structure to train the private model set, based on at least one training option selected by the user;
evaluate a performance of the private model set, using a test dataset; and
when the performance of the private model satisfies another given criteria, generate a second unique code for the private model set, wherein the second unique code is sent to the user device to allow said user device to access the private model set.

6. A method for recommending an Artificial Intelligence (AI) model, the method comprising:
receiving a first input, from a user device (104) associated with a user, upon receiving a user prompt at a user interface of the user device, wherein the first input comprises an application requirement of the user;
processing the first input and compare said first input to each AI model from amongst a plurality of AI models, to determine one or more AI models from amongst the plurality of AI models that match the first input;
receiving a second input, from a user device associated with a user, the second input comprising data related to the first input;
processing the second input by each of the one or more AI models to generate at least one response;
evaluating each of the at least one response to determine a ranking of corresponding AI models based on their relevance to the second input;
when the ranking of corresponding AI models lies above a predefined threshold, identifying a set of AI models from amongst the one or more AI models; and
generating a first unique code for each AI model of the set, wherein the first unique code of corresponding AI model of the set is sent to the user device, as selected by the user, to allow said user device to access any AI model of the set.

7. The method for recommending an Artificial Intelligence (AI) model, according to claim 6, further comprising:
receiving a user request, from the user device (104), wherein the user request comprises the first unique code;
processing the user request to identify the corresponding AI model of from the set, based on the first unique code; and
transmitting the corresponding AI model to the user device, wherein the user device comprises a processor (106) that is communicably coupled with the processing unit, configured to comprise:
receiving the corresponding AI model at the user device;
evaluating a performance of the corresponding AI model, based on an example dataset related to the first input; and
generating and sending feedback report of the performance of the corresponding AI model, to the processing unit.
